(19) United States
(12) Patent Application Publication
(10) Pub. No.: US 2020/0374391 A1
(43) Pub. Date: Nov. 26, 2020

(54) ELECTRONIC DEVICE FOR PROVIDING TELEPHONE NUMBER ASSOCIATED INFORMATION, AND OPERATION METHOD THEREFOR

(71) Applicant: Samsung Electronics Co., Ltd., Suwon-si, Gyeonggi-do (KR)

(72) Inventors: Michal Piotr MURGRABIA, Warszawa (PL); Krzysztof WILKOSZ, Warszawa (PL); Szymon LESKI, Warszawa (PL)

(21) Appl. No.: 16/955,467

(22) PCT Filed: Dec. 21, 2018
(86) PCT No.: PCT/KR2018/016488

§ 371 Date: Jun. 18, 2020

(30) Foreign Application Priority Data
Dec. 21, 2017 (KR) 10-2017-0176787

(51) Int. Cl. H04M 3/42; H04M 1/27457; H04M 1/2757; H04M 1/27475; H04M 1/725

(52) U.S. Cl. CPC H04M 3/42068; H04M 1/27457; H04M 1/72583; H04M 1/27475; H04M 1/2757

(57) ABSTRACT

The present disclosure pertains to an artificial intelligence (AI) system that imitates functions such as cognition, judgment and the like of a human brain using a machine learning algorithm like deep learning and the like, and its applications. Various embodiments of the present invention disclose a method and an apparatus for providing telephone number associated information. According to various embodiments of the present invention, an electronic device may comprise a display device and a processor, wherein the processor is configured, when a particular telephone number is detected, to obtain data associated with the telephone number, to extract first information that represents the telephone number and second information that is base data for the extraction of the first information from the associated data according to a predetermined criterion, and to display the telephone number and the first information onto the display device.

### CROSS-REFERENCE TO RELATED APPLICATION(S)

This application is a U.S. National Stage application under 35 U.S.C. § 371 of an International application number PCT/KR2018/016488, filed on Dec. 21, 2018, which is based on and claimed priority of a Korean patent application number 10-2017-0176787, filed on Dec. 21, 2017, in the Korean Intellectual Property Office, the disclosure of which is incorporated by reference herein in its entirety.

### TECHNICAL FIELD

The disclosure relates to a method and an apparatus for providing telephone number-associated information.

### BACKGROUND ART

An Artificial Intelligence (AI) system is a computer system for implementing intelligence at the level of human intelligence, in which a machine learns, judges, and becomes smarter by itself, unlike the conventional rule-based smart system. With use, the AI system may improve a recognition rate and more accurately understand a user's preferences, and thus the conventional rule-based smart system has been gradually replaced with a deep-learning-based AI system.

AI technology includes machine learning (deep-learning) and element technologies using machine learning.

Machine learning is algorithm technology of autonomously classifying/learning features of input data, and element technology is technology of simulating cognitive and judgment functions of human brains on the basis of a machine-learning algorithm such as a deep-learning algorithm and includes technology fields such as linguistic understanding, visual understanding, inference/prediction, knowledge representation, and operation control.

Various fields to which AI technology is applied are as follows. Linguistic understanding is technology for recognizing and applying/processing human languages/characters and may include natural language processing, machine translation, dialogue systems, question-and-answer systems, and voice recognition/synthesis. Visual understanding is technology for recognizing and processing an object in the manner of human vision, and includes object recognition, object tracking, image searching, person recognition, scene understanding, space understanding, and image improvement. Inference prediction is technology for determining information to logically infer and predict the same, and includes knowledge/probability-based inference, optimization prediction, preference-based plan, and recommendation. Knowledge representation is technology for automatic processing of information on human experience to obtain knowledge data, and includes knowledge construction (data creation/classification) and knowledge management (data use). Operation control is technology for controlling autonomous driving of vehicles and movement of robots, and includes movement control (navigation, collision, and driving) and manipulation control (behavior control).

With the development of digital technology, electronic devices having mobility and capable of processing communication and/or information, such as mobile communication terminals, Personal Digital Assistants (PDAs), electronic notebooks, smart phones, tablet Personal Computers (PCs), or wearable devices, have been supplied. The electronic device may receive various pieces of data including voice or character data from another electronic device through wireless communication as well as wired communication. The electronic device may identify another electronic device using, for example, a phone number and, when the phone number is stored in a phone book of the electronic device, provide relevant information stored along with the phone number. However, when the corresponding phone number is not stored in the phone book, other relevant information except for the phone number cannot be provided.

### DISCLOSURE OF INVENTION

### Technical Problem

An electronic device according to various embodiments may extract and provide information associated with a non-identified phone number.

An electronic device according to various embodiments may acquire and analyze data associated with a non-identified phone number and provide one or more pieces of information.

The technical subjects pursued in the disclosure may not be limited to the above mentioned technical subjects, and other technical subjects which are not mentioned may be clearly understood, through the following descriptions, by those skilled in the art of the disclosure.

### Solution to Problem

In accordance with an aspect of the disclosure, an electronic device is provided. The electronic device includes: a display device; and a processor, wherein the processor is configured to, when a specific phone number is detected, acquire data associated with the phone number, extract first information representing the phone number from the associated data and base data of extraction of the first information as second information according to a preset reference, and display the phone number and the first information on the display device.

In accordance with another aspect of the disclosure, a method of an electronic device is provided. The method includes: acquiring data associated with a specific phone number; extracting first information representing the phone number from the associated data and base information of extraction of the first information as second information according to a preset reference; and displaying the phone number and the first information on a display device.

### Advantageous Effects of Invention

An electronic device and a method according to various embodiments can acquire data associated with an unidentified phone number from various sources.

An electronic device and a method according to various embodiments can provide information that represents an unidentified phone number by analyzing data associated with the unidentified phone number.

An electronic device according to various embodiments can provide accuracy of information that represents an unidentified phone number or data for decision.

The effects that can be realized by the disclosure are not limited to the above-described effects, and other effects that have not been mentioned may be clearly understood by those skilled in the art from the following description.

### BRIEF DESCRIPTION OF DRAWINGS

FIG. 1 illustrates an example of an electronic device for providing phone number-associated information of another device within a network environment according to various embodiments;

FIG. 2 illustrates an example of a display device for providing phone number-associated information of another device according to various embodiments;

FIG. 3 illustrates an example of a function-processing module for providing phone number-associated information of another device according to various embodiments;

FIG. 4 illustrates an example of an operation of the electronic device according to various embodiments;

FIG. 5 illustrates another example of the operation of the electronic device according to various embodiments;

FIG. 6 illustrates another example of the operation of the electronic device according to various embodiments;

FIGS. 7A and 7B illustrate examples of a UI of an electronic device according to various embodiments;

FIGS. 8A and 8B illustrate other examples of the UI of the electronic device according to various embodiments;

FIG. 9 illustrates another example of the UI of the electronic device according to various embodiments;

FIG. 10 illustrates another example of the UI of the electronic device according to various embodiments;

FIG. 11 illustrates another example of the UI of the electronic device according to various embodiments;

FIGS. 12A and 12B illustrate other examples of the UI of the electronic device according to various embodiments;

FIGS. 13A and 13B illustrate other examples of the UI of the electronic device according to various embodiments;

FIGS. 14A and 14B illustrate other examples of the UI of the electronic device according to various embodiments;

FIGS. 15A and 15B illustrate other examples of the UI of the electronic device according to various embodiments; and

FIG. 16 illustrates another example of the operation of the electronic device for changing first information depending on a phone number storage pattern according to various embodiments.

### BEST MODE FOR CARRYING OUT THE INVENTION

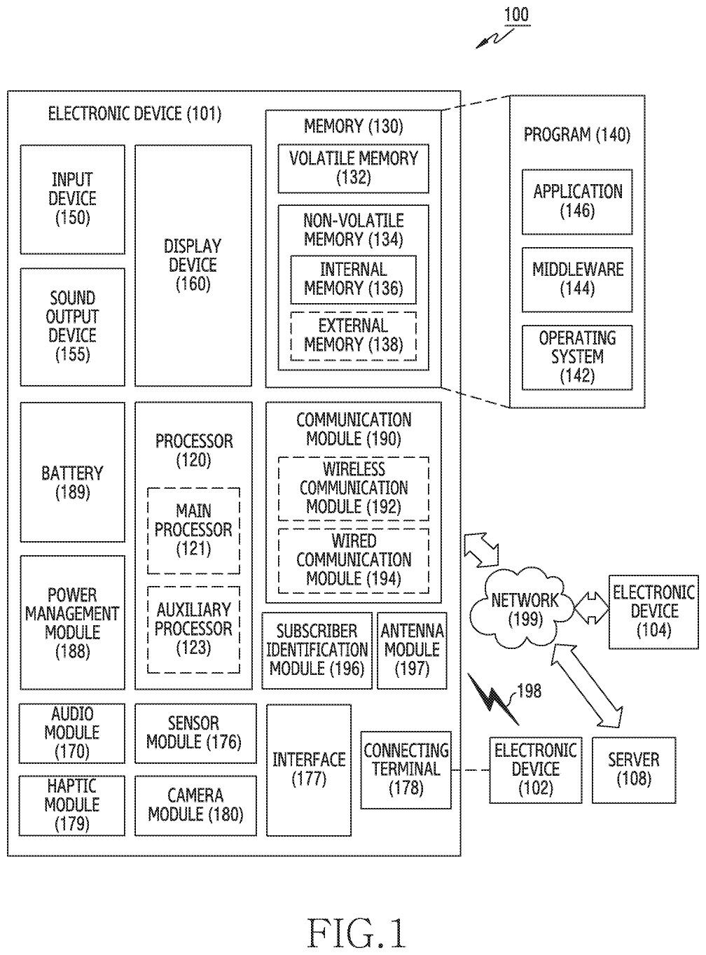

FIG. 1 is a block diagram of an electronic device in a network environment according to an embodiment of the disclosure. Referring to FIG. 1, an electronic device 101 may communicate with an electronic device 102 through a first network 198 (e.g., a short-range wireless communication) or may communicate with an electronic device 104 or a server 108 through a second network 199 (e.g., a long-distance wireless communication) in a network environment 100. According to an embodiment, the electronic device 101 may communicate with the electronic device 104 through the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, and an antenna module 197. According to some embodiments, at least one (e.g., the display device 160 or the camera module 180) among components of the electronic device 101 may be omitted or other components may be added to the electronic device 101. According to some embodiments, some components may be integrated and implemented as in the case of the sensor module 176 (e.g., a fingerprint sensor, an iris sensor, or an illuminance sensor) embedded in the display device 160 (e.g., a display).

The processor 120 may operate, for example, software (e.g., a program 140) to control at least one of other components (e.g., a hardware or software component) of the electronic device 101 connected to the processor 120 and may process and compute a variety of data. The processor 120 may load a command set or data, which is received from other components (e.g., the sensor module 176 or the communication module 190), into a volatile memory 132, may process the loaded command or data, and may store result data into a non-volatile memory 134. According to an embodiment, the processor 120 may include a main processor 121 (e.g., a central processing unit or an application processor) and an auxiliary processor 123 (e.g., a graphic processing device, an image signal processor, a sensor hub processor, or a communication processor), which operates independently from the main processor 121, additionally or alternatively uses less power than the main processor 121, or is specified to a designated function. In this case, the auxiliary processor 123 may operate separately from the main processor 121 or embedded.

In this case, the auxiliary processor 123 may control, for example, at least some of functions or states associated with at least one component (e.g., the display device 160, the sensor module 176, or the communication module 190) among the components of the electronic device 101 instead of the main processor 121 while the main processor 121 is in an inactive (e.g., sleep) state or together with the main processor 121 while the main processor 121 is in an active (e.g., an application execution) state. According to an embodiment, the auxiliary processor 123 (e.g., the image signal processor or the communication processor) may be implemented as a part of another component (e.g., the camera module 180 or the communication module 190) that is functionally related to the auxiliary processor 123.

The memory 130 may store a variety of data used by at least one component (e.g., the processor 120 or the sensor module 176) of the electronic device 101, for example, software (e.g., the program 140) and input data or output data with respect to commands associated with the software. The memory 130 may include the volatile memory 132 or the non-volatile memory 134.

The program 140 may be stored in the memory 130 as software and may include, for example, an operating system (OS) 142, a middleware 144, or an application 146.

The input device 150 may be a device for receiving a command or data, which is used for a component (e.g., the processor 120) of the electronic device 101, from an outside (e.g., a user) of the electronic device 101 and may include, for example, a microphone, a mouse, or a keyboard.

The sound output device 155 may be a device for outputting a sound signal to the outside of the electronic device 101 and may include, for example, a speaker used for general purposes, such as multimedia play or recordings play, and a receiver used only for receiving calls. According to an embodiment, the receiver and the speaker may be either integrally or separately implemented.

The display device 160 may be a device for visually presenting information to the user of the electronic device 101 and may include, for example, a display, a hologram device, or a projector and a control circuit for controlling a corresponding device. According to an embodiment, the display device 160 may include a touch circuitry or a pressure sensor for measuring an intensity of pressure on the touch.

The audio module 170 may convert a sound and an electrical signal in dual directions. According to an embodiment, the audio module 170 may obtain the sound through the input device 150 or may output the sound through an external electronic device (e.g., the electronic device 102 (e.g., a speaker or a headphone)) wired or wirelessly connected to the sound output device 155 or the electronic device 101.

The sensor module 176 may generate an electrical signal or a data value corresponding to an operating state (e.g., power or temperature) inside or an environmental state outside the electronic device 101. The sensor module 176 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 177 may support a designated protocol wired or wirelessly connected to the external electronic device (e.g., the electronic device 102). According to an embodiment, the interface 177 may include, for example, a high-definition multimedia interface (HDMI), a universal serial bus (USB) interface, a secure digital (SD) card interface, or an audio interface.

A connecting terminal 178 may include a connector that physically connects the electronic device 101 to the external electronic device (e.g., the electronic device 102), for example, an HDMI connector, a USB connector, an SD card connector, or an audio connector (e.g., a headphone connector).

The haptic module 179 may convert an electrical signal to a mechanical stimulation (e.g., vibration or movement) or an electrical stimulation perceived by the user through tactile or kinesthetic sensations. The haptic module 179 may include, for example, a motor, a piezoelectric element, or an electric stimulator.

The camera module 180 may shoot a still image or a video image. According to an embodiment, the camera module 180 may include, for example, at least one lens, an image sensor, an image signal processor, or a flash.

The power management module 188 may be a module for managing power supplied to the electronic device 101 and may serve as at least a part of a power management integrated circuit (PMIC).

The battery 189 may be a device for supplying power to at least one component of the electronic device 101 and may include, for example, a non-rechargeable (primary) battery, a rechargeable (secondary) battery, or a fuel cell.

The communication module 190 may establish a wired or wireless communication channel between the electronic device 101 and the external electronic device (e.g., the electronic device 102, the electronic device 104, or the server 108) and support communication execution through the established communication channel. The communication module 190 may include at least one communication processor operating independently from the processor 120 (e.g., the application processor) and supporting the wired communication or the wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication module) and may communicate with the external electronic device using a corresponding communication module among them through the first network 198 (e.g., the short-range communication network such as a Bluetooth, a Wi-Fi direct, or an infrared data association (IrDA)) or the second network 199 (e.g., a long-distance wireless communication network such as a cellular network, an internet, or a computer network (e.g., LAN or wide area network (WAN)). The above-mentioned various communication modules may be implemented into one chip or into separate chips, respectively.

According to an embodiment, the wireless communication module 192 may identify and authenticate the electronic device 101 using user information stored in the subscriber identification module 196 in the communication network.

The antenna module 197 may include one or more antennas to transmit or receive the signal or power to or from an external source. According to an embodiment, the communication module 190 (e.g., the wireless communication module 192) may transmit or receive the signal to or from the external electronic device through the antenna suitable for the communication method.

Some components among the components may be connected to each other through a communication method (e.g., a bus, a general purpose input/output (GIPO), a serial peripheral interface (SPI), or a mobile industry processor interface (MIPI)) used between peripheral devices to exchange signals (e.g., a command or data) with each other.

According to an embodiment, the command or data may be transmitted or received between the electronic device 101 and the electronic device 104 through the server 108 connected to the second network 199. Each of the electronic devices 102 and 104 may be the same or different types as or from the electronic device 101.

According to an embodiment, all or some of the operations performed by the electronic device 101 may be performed by another electronic device or a plurality of external electronic devices 102 or 104. When the electronic device 101 performs some functions or services automatically or by request, the electronic device 101 may request the external electronic device 102 or 104 to perform at least some of the functions related to the functions or services, in addition to or instead of performing the functions or services by itself. The external electronic device 102 or 104 receiving the request may carry out the requested function or the additional function and transmit the result to the electronic device 101. The electronic device 101 may provide the requested functions or services based on the received result as is or after additionally processing the received result. To this end, for example, a cloud computing, distributed computing, or client-server computing technology may be used.

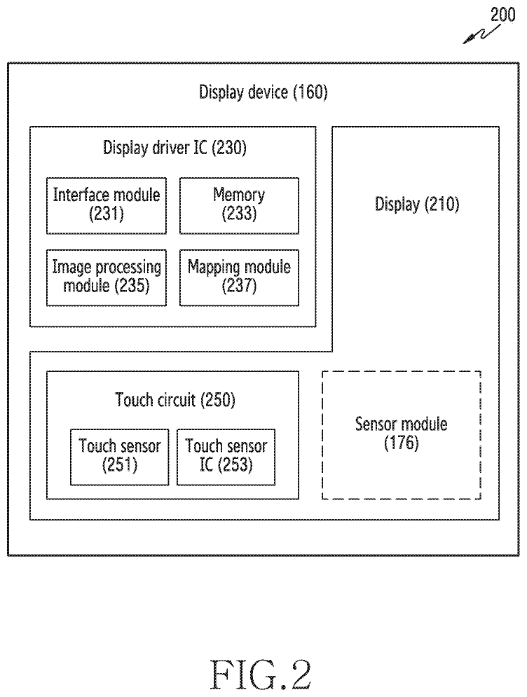

FIG. 2 illustrates an example of a display device according to various embodiments.

Referring to FIG. 2, the display device 160 may include a display 210 and a Display Driver IC (DDI) 230 for controlling the display. The DDI 230 may include an interface module 231, a memory 233 (for example, a buffer memory), an image processing module 235, or a mapping module 237.

The DDI 230 may receive image data or image information including an image control signal corresponding to a command for controlling the image data from the processor 120 (For example, a main processor 121 (For example, an application processor) or an auxiliary processor 123 operating independently from a function of the main processor 121) through, for example, the interface module 231. The DDI 230 may communicate with a touch circuit 250 or a sensor module 176 through the interface module 231. Further, the DDI 230 may store at least some of the received image information in a memory 233 in units of, for example, frames.

The image processing module 235 may perform pre-processing or post-processing (for example, controlling the resolution, brightness, or size) on at least some of the image data based at least on a characteristic of the image data or a characteristic of the display 210.

The mapping module 237 may convert the image data pre-processed or post-processed through the image processing module 135 into a voltage value or a current value for driving pixels on the basis of at least some of attributes of pixels of the display 210 (for example, arraignment of pixels (RGB stripe or pentile) or the size of each sub pixel). At least some pixels of the display 210 may be driven on the basis of, for example, the voltage value or the current value, so that visual information corresponding to the image data (for example, text, images, or icons) may be displayed on the display 210.

According to an embodiment, the display 160 may further include the touch circuit 250. The touch circuit 250 may include a touch sensor 251 and a touch sensor IC 253 for controlling the touch sensor. The touch sensor IC 253 may measure a signal change in a specific location of the display 210 (for example, voltage, an amount of light, resistance, or an amount of charge) by controlling the touch sensor 251 and detect a touch input or a hovering input at the specific location, so as to provide information on the detected touch input or hovering input (for example, location, area, pressure, or time) to the processor 120. According to an embodiment, at least some of the touch circuit 250 (for example, the touch sensor IC 253) may be included as a part of the DDI 230 or the display 210 or a part of another element (for example, the auxiliary processor 123) disposed outside the display device 160.

According to an embodiment, the display device 160 may further include at least one sensor of the sensor module 176 (for example, a fingerprint sensor, an iris sensor, a pressure sensor, or an illumination sensor) or a control circuit therefor. In this case, at least one sensor or the control circuit therefor may be implemented to be embedded into the part of the display device 160 (for example, the display 210 or the DDI 230) or the part of the touch circuit 250.

For example, when the sensor module 176 embedded into the display device 160 includes a biometric sensor (for example, a fingerprint sensor), the biometric sensor may acquire biometric information (for example, a fingerprint image) related to a touch input through some areas of the display 210. In another example, when the sensor module 176 embedded into the display device 160 includes a pressure sensor, the pressure sensor may acquire pressure information on a touch input through some or all of the areas of the display 210. According to an embodiment, the touch sensor 251 or the sensor module 176 may be disposed between pixel layers of the display 210, or on or below the pixel layer.

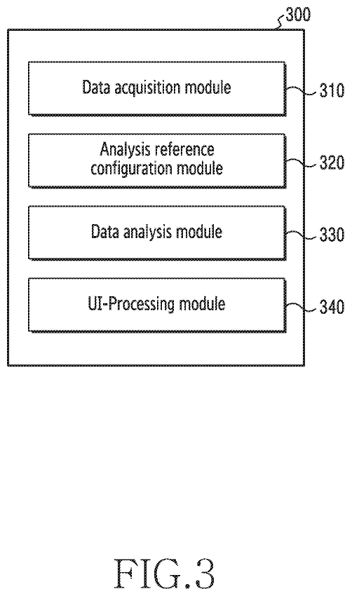

FIG. 3 illustrates an example of a function-processing module of an electronic device according to various embodiments of the disclosure.

As illustrated in FIG. 3, FIG. 3 illustrates an example of a function-processing module 300 related to a function for, when an electronic device (for example, the electronic device 101 of FIG. 1) according to various embodiments provides phone number-associated information, acquiring various prices of data on a phone number, analyzing the acquired data, extracting representative information, and configuring and displaying text and visual information. According to various embodiments, the function-processing module 300 may be included as a hardware module or a software module in a processor (for example, the processor 120 of FIG. 1) having processing circuitry.

Referring to FIG. 3, the function-processing module 300 may process an operation of providing phone number-associated information of another electronic device. According to various embodiments, the function-processing module 300 may be implemented as a software or hardware device through separation of elements thereof or a combination of at least two elements. The function-processing module 300 may be devices that are implemented through at least one of the processor 120, the memory 130, the communication module 190, the display 160 (for example, the display 210), and other elements, as illustrated in FIG. 1, to acquire and analyze data associated with various embodiments and process a UI or a GUI according thereto. Unlike this, at least some elements of the function-processing module 300 may be implemented in the cloud including various devices including an external device, for example, the server 108, executed through communication between the electronic device 101 and another electronic device 102 or 104, another external device, or another server 108, and provided to the electronic device 101. The function-processing module 300 may include a data acquisition module 310, an analysis reference configuration module 320, a data analysis module 330, and a UI display processing module 340.

The data acquisition module 310 may acquire the detected phone number-associated data from various external servers such as various external devices or a web server through the memory 130 or the communication module 190. The phone number-associated data may include various messages such as a Short Message Service (SMS), a Multimedia Message Service (MMS), a Long Message Service (LSM), and an Instant Message (IM), a webpage on the Internet, data extracted from various images or various pieces of data acquired from a voice call through voice recognition. The phone number-associated data may also include context information. The context information is additional information and includes various pieces of additional information, for example, a time at which the phone number is detected, a date, day of week, a number of detections, a location of the electronic device at a time point of detection, an app executed at a time point of detection, data on another neighboring device detected through, for example, short-range communication (NFC or Wi-Fi) around the detection location, user emotion that may be extracted through communication such as a voice call or a video call, or social relation inference information.

According to various embodiments, the phone number-associated data may be acquired from various sources including various servers capable of communicating with the electronic device 101 including a storage device (for example, the memory 130) within the electronic device 101, another electronic device 102 or 104, the server 108, a web server (not shown), a message server, or a content provision server (not shown) of a service provider.

The analysis reference configuration module 320 may analyze phone number-associated data and configure a reference required for extracting associated information. Associated information to be extracted includes text information that represents a phone number, for example, text information such as a user name, a company name, or a group name. The analysis reference may include at least one reference template for analyzing grammar by performing comparison with text data and extracting at least one candidate noun. The analysis reference may be individually configured according to a format of the acquired text data or a format of the original data. For example, for data acquired from a text message, a single isolated word may be extracted as a candidate noun according to general text message grammar. In the case of text by voice recognition of a voice call, a word next to self-introduction may be extracted as a candidate noun according to general grammatical composition of telephone conversation. In the case of text extracted from the visited webpage, a part of the title of the webpage including a phone number may be a candidate noun. The analysis reference may include a reference table in which a plurality of pieces of context information match a plurality of group names in order to recommend a candidate noun such as a group name from which social relations between users can be inferred on the basis of various pieces of context information.

The data analysis module 330 analyzes the acquired phone number-associated data according to an analysis reference configured by the analysis reference configuration module 320. The data analysis module 330 may analyze the acquired data on the basis of, for example, an analysis reference corresponding to a source of the acquired data. At this time, the data analysis module 330 may perform a comparison with data acquired using a reference template of the corresponding sources and extract a candidate noun from text data or recommend a candidate noun such as a group name on the basis of context information. The data analysis module 330 may provide information that is the basis of recommendation of the corresponding candidate noun. For example, the data analysis module 330 may provide some of the text data including the corresponding candidate noun, a part that matches a grammatical structure or context information of text including the corresponding candidate noun in the reference template or the reference table to be compared for extraction of the corresponding candidate noun, and accuracy of the representative nature of the candidate noun for the corresponding phone number of candidate nouns. The accuracy may include, for example, simply the number of matchings with the reference template or the reference table or information indicating a sum of different weighted values for various references included therein as a probability. Accordingly, the data analysis module 330 may finally extract phone number-associated information from a plurality of candidate nouns on the basis of the base information.

The UI-processing module 340 may be implemented as a software component stored in the memory 130, a hardware component loaded therefrom and executed by the processor 120, or a combination thereof. The UI-processing module 340 may be implemented to configure the extracted phone number-associated information and recommended base information of the corresponding associated information in the form of text and/or visual items and display the text and/or visual items on the display device 160. According to various embodiments, a method of configuring and displaying the text and the visual items will be described in detail with reference to the accompanying drawings. According to an embodiment, the text and the visual items may be configured to be correlated with each other. To this end, for example, the text and the visual items may be applied to be balanced by arranging the display location of the text and the visual items in the same row or column, or an area within a preset distance or making colors of the text and the visual items or colors of backgrounds in which the text and the visual items are arranged the same as or similar to each other. For example, a color may include three attributes of hue, brightness, and saturation, and making at least one of the three attributes the same or similar may give the sense of unity.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

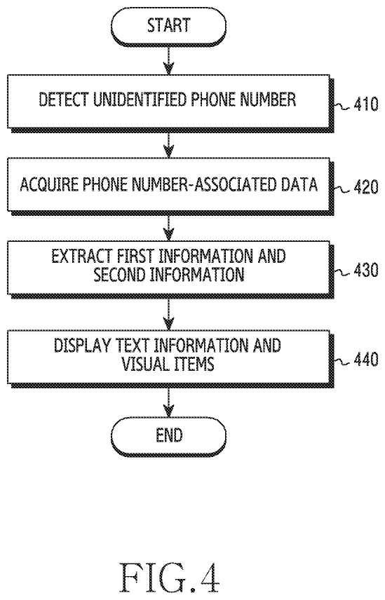

FIG. 4 illustrates an example of an operation of the electronic device according to various embodiments. Referring to FIG. 4, in operation 410, the processor 120 of the electronic device 101 detects a phone number. The phone number may include, for example, serial numbers used to identify different communication devices in a Public Switched Telephone Network (PSTN), and include unique identifiers used to identify different devices in the same network or different networks regardless of a name thereof.

A phone number may be detected from a phone of a sender or a receiver of an incoming or outgoing voice call or message. Further, the phone number may be detected from content of an incoming or outgoing voice call or message or detected from content included in a webpage visited through an electronic device.

The processor 120 may compare the detected phone number with a phone number stored in the electronic device and determine whether the detected phone number is the stored phone number of a non-identified phone number. Hereinafter, an operation for acquiring and analyzing data associated with the non-identified phone number is described, but data associated with a phone number stored in a phone book may be acquired, analyzed, and provided as necessary.

According to various embodiments, an operation for detecting a phone number and analyzing associated data may be performed in two modes separately or in parallel. First, when a corresponding sender phone number is detected according to termination or origination of a voice call or a message, available associated data may be immediately acquired and analyzed and thus associated information may be extracted. Alternatively, in a background operation mode, phone numbers detected according to all communications performed by the electronic device, for example, data associated with phone numbers stored in a phone book, unidentified phone numbers, and phone numbers acquired according to visit to a webpage may be collected and analyzed, associated information extracted along with valid associated data for each phone number may be indexed, classified, and stored, and provided as necessary.

In operation 420, the processor 120 acquires data associated with the detected phone number from various sources. Data associated with the detected phone number may be acquired from the memory of the electronic device or various external devices as described above. Phone number-associated data includes various pieces of data generated in all types of formats of data such as text, images, content, or voice calls, and video calls transmitted and received on the basis of the detected phone number as a receiver or sender phone number. Further, the phone number-associated data includes various pieces of data including the detected phone number. Accordingly, the associated data includes text data acquired from various text messages such as SMS, MMS, LSM, and IM, text data recognized through a voice call or a video call and converted, and text data recognized and converted from image data acquired from various sources such as a message, a video call, and a webpage in the Internet. In order to acquire associated data, the processor 120 may recognize a voice through, for example, a voice recognition program and convert the voice into text or recognize an image through an image recognition program such as a character reading program (for example, an optical character reader) and convert the image into text.

Context information that is one piece of the phone number-associated data may include not only the above-described data but also various pieces of information for estimating an emotional state such as a voice tone, an emoticon, and a facial expression acquired through various communications and various pieces of information for inferring social relations between users such as a sentence pattern or a type of a used word including the honorific or a name used in data acquired through a message, a voice call, or a video call as well as the above-described data.

In operation 430, the processor 120 may analyze the acquired data according to a preset reference and extract first information that represents a phone number and second information that is information associated with the first information.

To this end, the processor 120 may load a reference template which is a preset reference in accordance with a format of the acquired data or a format of the original data and compare the reference template of the acquired data with the acquired data so as to extract a candidate word as the first information. The first information may be called name information indicating information such as a name that represents a phone number. The reference template which is a reference for analyzing a text message may be configured to extract a word located at the first part or the last part as a candidate word that is identification information indicating a name of a sender according to the location of the word in the message including a plurality of words. The reference template may be implemented to configure a dictionary with normal words generally included in a text message and extract a word which is not included in the dictionary as a proper noun candidate word. The reference template may vary depending on a language. For example, in the case of English, a word starting with a capital letter may be extracted as a proper noun candidate word. In the case of a voice call, a word next to a greeting may be extracted as a proper noun candidate word in that a format of a phone call is standardized.

Meanwhile, the corresponding element of the reference template used to extract a candidate word and data that is the basis of extraction of the candidate word such as data including the candidate word may be calculated along with the candidate word as second information and used to calculate accuracy of the candidate word. The second information may be called base information indicating information that is the basis of extraction of the candidate word. The reference template may be implemented to calculate accuracy by adding a score whenever the candidate word in the acquired phone number-associated data matches the element defined in the reference template. Further, when matching is performed by assigning different weighted values to elements of the reference template, accuracy may be calculated by assigning scores of different weighted values and summing up the scores. Meanwhile, an evaluation reference of the reference template and the weighting elements of the reference template may be updated and learned through adjustment according to whether the user accepts a candidate word extracted by applying the corresponding reference template.

Further, a name that may represent a phone number as well as a candidate word included in associated data may be extracted as first information on the basis of not only the reference template but also a reference for analyzing and extracting information such as a reference table. For example, through the reference template or the reference table, information that may represent social relations between users of the electronic device 101 and another electronic device may be extracted as first information. The information that represents social relations may be classified into, for example, friends, acquaintances, strangers, and business relationships. To this end, the reference template or the reference table may include, for example, specific words indicating formal, informal, or social relations, a sentence structure, or words indicating emotion. Also, the first information indicating social relations may match various pieces of context information such as a number of communications with another electronic device, a number of detections of a phone number of another electronic device, a time of the detection, the day of week, or a date of detection, a word from which the purpose of communication can be inferred, a voice tone indicating emotion, and emotions. The information that is the basis of matching and an accuracy score of the information that is the basis of the corresponding matching may be extracted as second information.

In operation 440, the processor 120 may display, on the display device 160, text information indicating first information extracted from the detected phone number-associated data to be linked with, for example, visual information indicating second information. The first information extracted as the phone number-associated data includes information indicating social relations with, for example, a name of the user of the detected phone number and/or the user of the electronic device 101. Further, the second information includes data that is the basis of extraction of the first information and/or an accuracy score of extraction of the first information.

The first information and the second information may include, for example, text and visual items. For example, the first information and the second information may be displayed to be mutually linked with each other on the same screen. On the other hand, after only the first information is displayed, the second information may be displayed in addition to the first information or to replace the first information according to a request. A method of displaying the first information and the second information may be variously configured in an interactive manner.

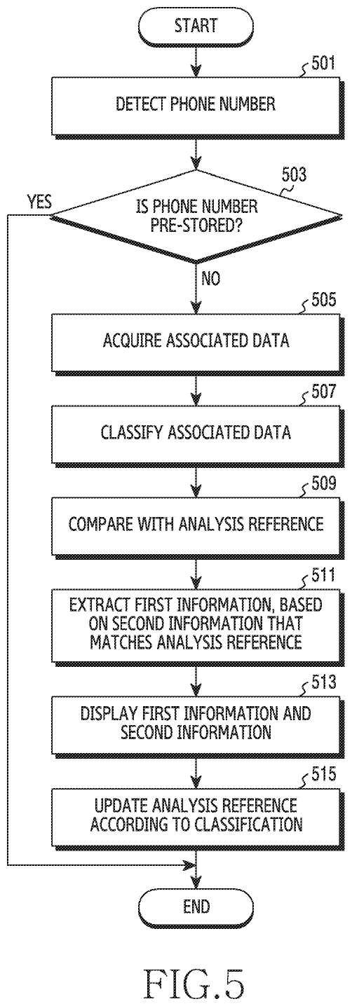

FIG. 5 illustrates another example of the operation of the electronic device according to various embodiments. Referring to FIG. 5, in operation 501, the processor 120 detects a phone number.

In operation 503, the processor 120 identifies whether the detected phone number is a phone number stored in the electronic device 101.

When the detected phone number is not the stored phone number, data associated with the detected phone number is acquired from various sources such as the inside of the electronic device, an external electronic device, or a server in operation 505. The phone number-associated data may be acquired from various sources when the phone number is detected or may be collected and stored whenever data is generated according to the operation performed by the electronic device.

In operation 507, the acquired phone number-associated data is classified according to a preset reference and stored as necessary. The phone number-associated data may be classified according to a source from which the data is acquired, for example, an identifier of the memory of an electronic device, an external electronic device, or an external server, classified into a text message service, an IM type, voice call recognition, or image recognition according to a type or a format of acquired data or original data type, classified into text data and data that can be switched to text data or information that is not switched to text such as context information, or classified according to a time and a location at which the phone number-associated data is generated. The phone number-associated data may be classified according to two or more classification references. A preset analysis reference of the data classified according to the type of acquired data or the type of original data may include, for example, at least one reference template for analyzing grammar by performing a comparison with text data as described above and extracting at least one candidate noun and/or a reference template for analyzing context information and proposing classification of social relations or intimacy.

The phone number-associated data is compared and analyzed according to the corresponding analysis reference in operation 509, and matching data that matches the reference is extracted from the acquired phone number-associated data as second information according to a comparison with the analysis reference, accuracy is calculated by applying a weighted value to the extracted second information, and first information representing the phone number is extracted therefrom in operation 511. At this time, the first information is a representative name extracted through, for example, associated data, and may include, for example, a user name or nickname, or a social relation name such as family, friend, colleague, business relationship, alumni, formal, or informal relations. The second information supporting the first information may include a part of associated data obtained by extracting the first information, a part of the reference template, or various pieces of context information. Further, the second information may include matching information according to a comparison with the reference template or base data of extraction of the first information such as a sum of weighted values of matching information and/or accuracy of extraction of the first information calculated on the basis thereof. That is, the second information is information that can be the basis of extraction of the first information according to, for example, an analysis reference supporting extraction of the first information or the basis of extraction of the first information according to a preset analysis reference and may be extracted from the analysis reference or phone number-associated data.

In operation 513, the extracted first information and/or second information may be displayed on the electronic device 101. At this time, the first information and/or the second information may include, for example, text and visual items. The first information and the second information may be displayed to be linked to each other on the same screen or only the first information is displayed and then the second information is displayed in addition to the first information or to replace the first information according to a request. A method of displaying the first information and the second information may be variously configured in an interactive manner.

In operation 515, the processor 120 updates the analysis reference with reference to extraction of the second information according to whether the first information is adopted and the reference for extraction of the first information from the second information. Further, the first information and/or the second information may be stored in the memory of the electronic device 101. At this time, the processor 120 may store the first information and the detected phone number together in, for example, a phone book of the electronic device 101. This will be described below in detail.

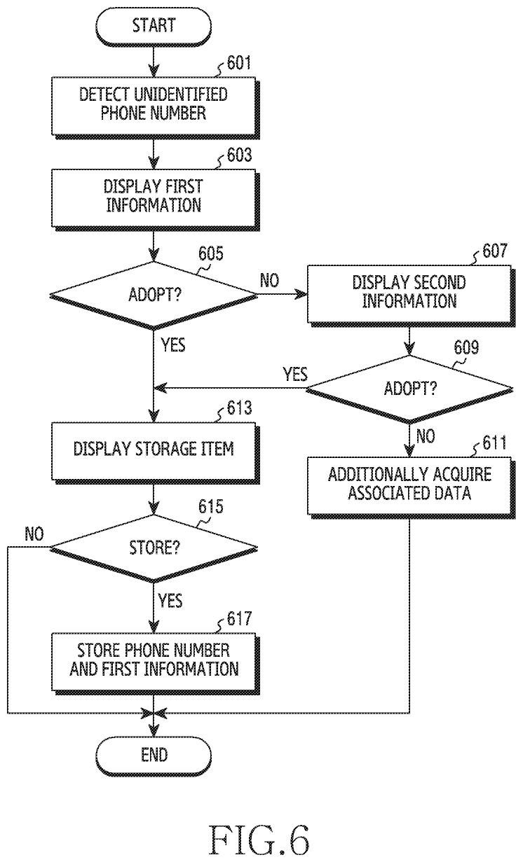

FIG. 6 illustrates another example of the operation of the electronic device according to various embodiments.

Referring to FIG. 6, in operation 601, the processor 120 detects a phone number when the phone number is input to receive an incoming call or send an outgoing call or when an event such as message reception or message list identification is generated.

In operation 603, the processor 120 displays the detected phone number and first information extracted from data associated with the corresponding phone number together.

In operation 605, it is identified whether the extracted first information on the corresponding phone number is adopted by the user. When the first information is not adopted, second information may be provided. At this time, for example, the second information may be provided only when the user selects an identification request for identifying the second information. Unlike this, the second information may be provided along with the first information before it is identified whether the first information is adopted rather than provided when the first information is not adopted.

When the first information is adopted according to displaying of the first information in operation 605 or when it is identified to adopt the first information according to displaying of the second information in operation 609, the processor 120 may automatically configure and display a storage item such as the adopted first information to be stored in, for example, a phone book along with the corresponding phone number immediately after the identification or after an event such as a corresponding call or message is terminated.

When the displayed storage item is identified and the user selects storage or does not reject storage for a preset time in operation 615, the processor 120 stores the corresponding phone number and the first information in the memory as the phone book according to the storage item in operation 617.

Meanwhile, when the second information displayed in operation 607 is identified and the first information is not adopted, the processor 120 store the acquired phone number-associated data along with analysis data such as the first information and the second information and additionally acquire data associated with the corresponding phone number in operation 611.

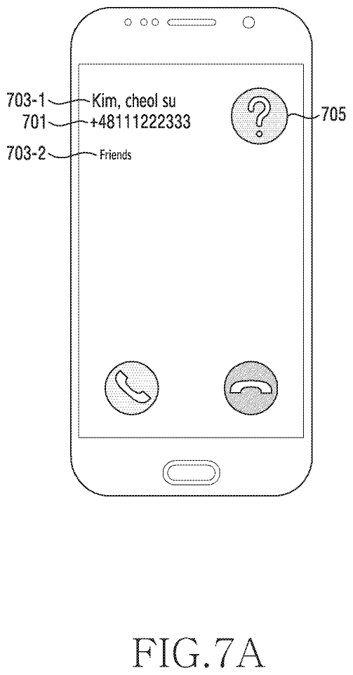

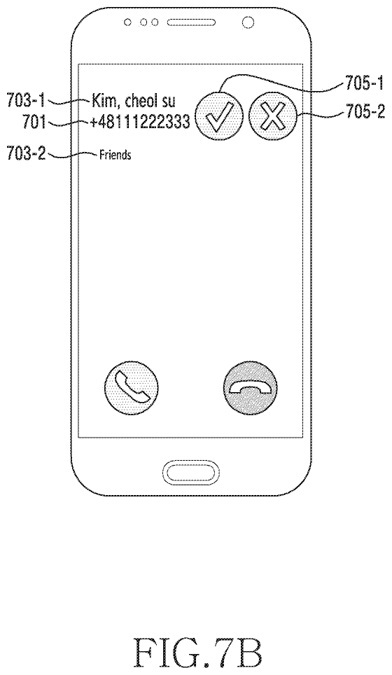

FIGS. 7A and 7B illustrate examples of a UI of an electronic device according to various embodiments.

Referring to FIGS. 7A and 7B, when an incoming call is received, the electronic device detects a corresponding phone number and displays first information 703-1 and 703-2 extracted from phone number-associated data together with the corresponding phone number 701 the display. The first information may include, for example, a name 703-1 of the user of the corresponding phone number and/or social relations 703-2 with the user of the corresponding phone number. Further, an icon 705 for receiving a response of the user such as identifying, adopting, or rejecting additional information of the first information in connection with the corresponding phone number may be displayed on the display. The icon 705 may include, for example, an image intuitively indicating the type of the user response. For example, the icon 705 may include a question mark image for identifying additional information such as second information as illustrated in FIG. 7A, or may include a plurality of icons such as a check image for adoption and an X image for rejection as illustrated in FIG. 7B.

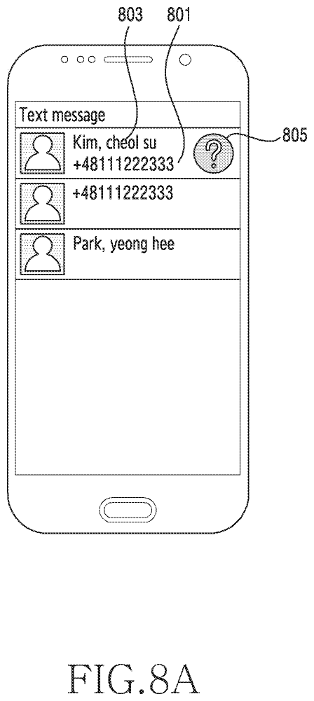

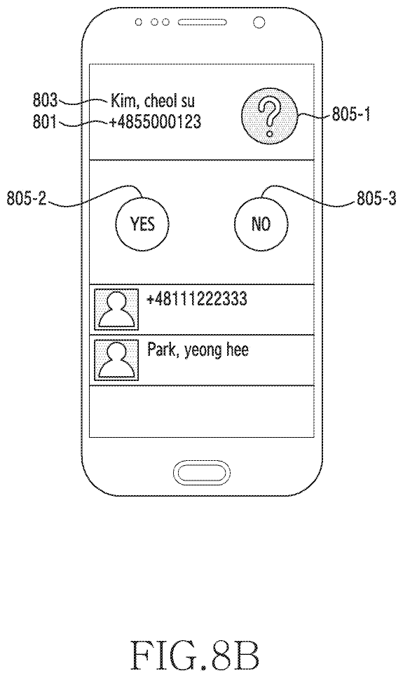

FIGS. 8A and 8B illustrate other examples of the UI of the electronic device according to various embodiments.

Referring to FIG. 8A, when a message is received or transmitted, the electronic device detects a phone number of a counterpart and display first information 803 extracted from phone number-associated data along with the corresponding phone number 801 on the display. The first information may include a name 803 of the user of the corresponding phone number as described above. Further, an icon 805 for identifying additional information of the first information in connection with the corresponding phone number may be displayed on the display.

Referring to FIG. 8B, when a message is received or transmitted, the electronic device displays a list of incoming messages or outgoing messages according to user selection. At this time, an unidentified phone number is detected in the message list, and the first information 803 extracted from data associated with the corresponding phone number may be displayed along with the corresponding phone number 801 on the display. Further, a plurality of icons 805-1, 805-2, and 805-3 may be displayed on the display and thus a user response to the extracted first information may be identified therethrough. The plurality of icons may include images or text corresponding to the user response. The icons may include, for example, a question mark image 805-1 for identifying additional information such as the second information or images or text such as positive text 805-2 for adopting the first information and negative text 805-3 for rejecting the first information.

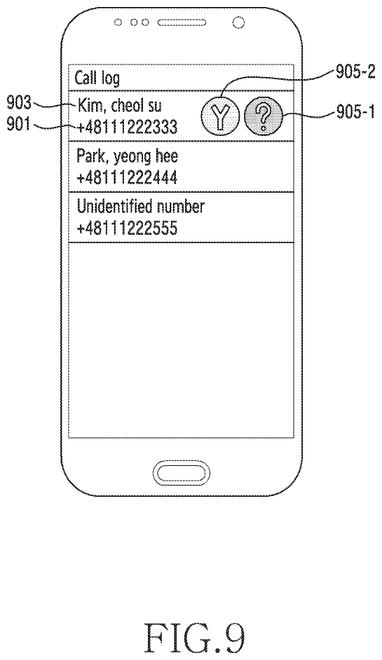

FIG. 9 illustrates another example of the UI of the electronic device according to various embodiments.

Referring to FIG. 9, even when associated data is not sufficient to extract first information on the corresponding phone number or when extracted first information is not adopted at the time point at which an incoming call is received, associated data may be collected and analyzed in a background mode and new first information may be extracted. Accordingly, the electronic device may display, for example, newly extracted first information 903 and a corresponding phone number 901 together in an incoming/outgoing call list. Further, the electronic device may display an icon 905-1 for identifying additional information and/or an icon 905-2 for adopting first information to include text and/or images indicating the type of the corresponding response on the left side or right side of the same row of the phone number to intuitively indicate that the icons are icons for the response to the corresponding phone number in the phone number list.

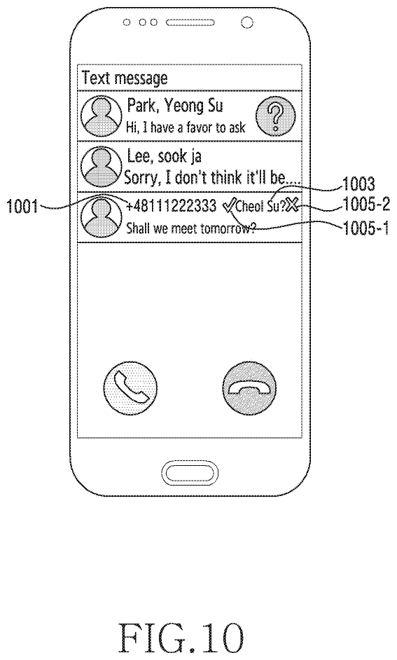

FIG. 10 illustrates another example of the UI of the electronic device according to various embodiments.

Referring to FIG. 10, when a message list is identified after an incoming message is received or an outgoing message is transmitted, first information may be presented. For example, even when associated data for extracting first information on the corresponding phone number is not sufficient or extracted first information is not adopted at the time point at which the message is received or transmitted, associated data may be collected and analyzed in a background mode and new first information may be extracted. Referring to FIG. 10, a phone number 1001 is displayed on the left side in the message list, and a name 1003 of the user of the corresponding phone number that is first information is displayed on the right side. Further, an icon 1005-1 for adopting the displayed user name 1003 may be displayed on the left side of the name 1003, and an icon 1005-2 for rejecting the user name 1003 may be displayed on the right side of the name 1003.

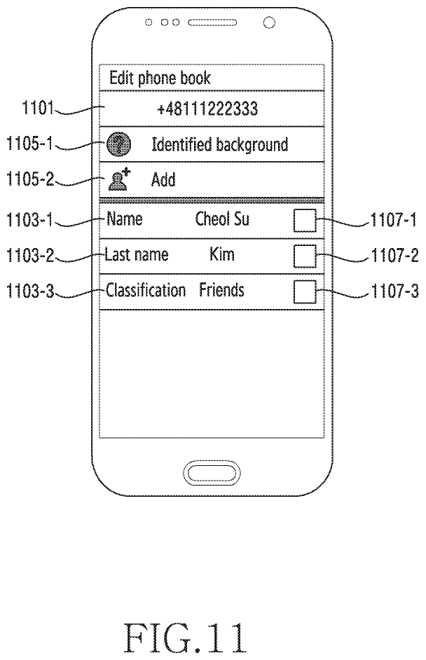

FIG. 11 illustrates another example of the UI of the electronic device according to various embodiments.

Referring to FIG. 11, when the detected phone number is not stored in the phone book, the electronic device may perform an operation for automatically storing adopted first information in the phone book when the corresponding call ends or after a predetermined time from identification of a message.

At this time, the processor may display a notification querying about whether to store the corresponding phone number and the first information on the display device. To this end, the electronic device may automatically display a phone book editing screen including the corresponding phone number and the first information and query about whether to store the phone number and the first information. Unlike this, when storage is selected after query about whether to store the corresponding phone number and the first information in the phone book is made, the phone book editing screen may be displayed. At this time, the phone book storage query that is a notification for querying about whether to perform storage may be displayed through a popup window on at least some of the display device on which a corresponding call-related screen or a message-related screen is displayed or displayed through an icon for selecting storage within the corresponding call-related screen or the message-related screen.

Referring to the phone book editing screen of FIG. 11, information corresponding to each item of the phone book editing screen in the first information may be automatically displayed. Accordingly, the user may check whether each item of the adopted first information is accurately displayed while watching the screen and may select, delete, or change each item using, for example, boxes 1107-1, 1107-2, and 1107-3. FIG. 11 is only an example, and the operation of linking the detected phone number and the adopted first information and storing the same in the phone book may be implemented such that respective items of the first information are not separately distinguished but the stored phone number and the corresponding first information are simply identified and stored, or the phone number and the first information may be immediately stored after a query about whether to store the phone number without a separate identification procedure when the first information on the corresponding phone number is adopted.

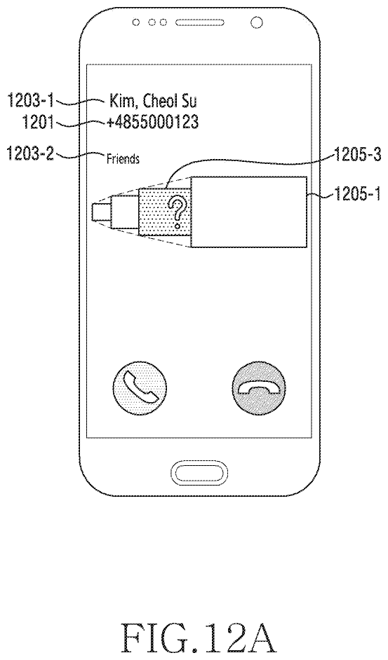

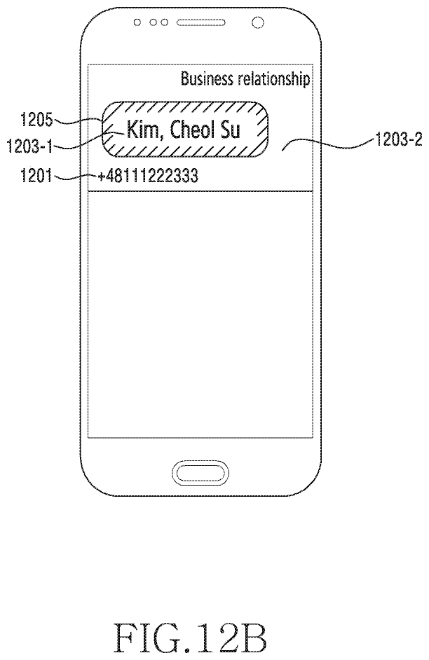

FIGS. 12A and 12B illustrate other examples of the UI of the electronic device according to various embodiments. Referring to FIG. 12A, first information 1203-1 and 1203-2 proposed for a phone number 1201 detected by the electronic device may be displayed, and second information related to the first information may be also displayed. At this time, the second information may be displayed as a visual item including, for example, text and/or an image. The displayed second information includes information that is the basis of proposal of the first information and/or accuracy scores of the information that is the basis of proposal of the first information. The visual item for the second information may be implemented to intuitively indicate the accuracy score of the second information through, for example, at least one of a color, a brightness, and an item size.

Referring to FIG. 12A, a plurality of FIGS. 1205-1 having different sizes are displayed, and an accuracy score that is second information is indicated by a size and a color of a corresponding figure by varying the color of one figure. Further, an icon 1205-3 may be displayed inside or around the corresponding size figure, and base information of calculation of the accuracy score may be identified when the icon 1205-3 is selected.

In FIG. 12B, a phone number 1201 detected by the electronic device and proposed first information 1203-1 and 1203-2 may be displayed together, and a FIG. 1205 including the displayed first information 1203-1 and 1203-2 and/or the phone number 1201 or at least some thereof may be displayed. The accuracy score of the proposed first information may be indicated by varying a size and/or a color, and/or a brightness of the corresponding figure. Also, the accuracy score of the first information may be indicated by making the FIG. 1205 flicker and varying a flickering speed. Unlike this, selection of an icon indicated by the FIG. 1205 is induced through flickering of the figure, and when the selection is made, the accuracy score may be separately displayed using text and/or an image.

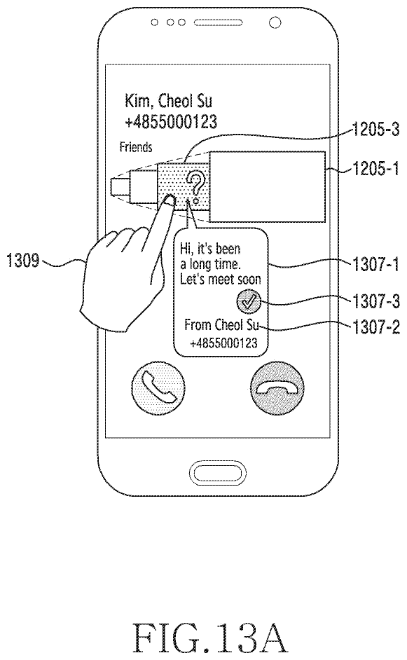

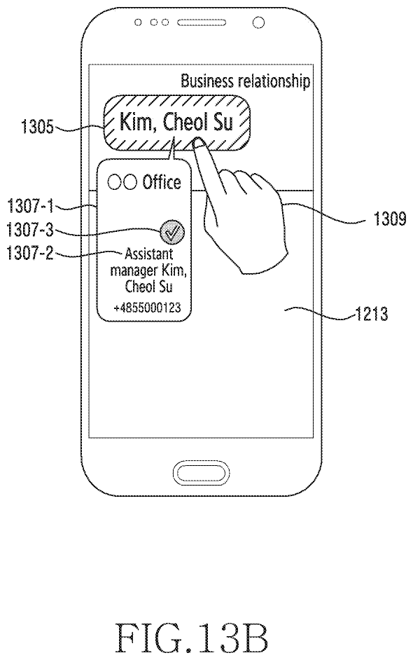

FIGS. 13A and 13B illustrate other examples of the UI of the electronic device according to various embodiments. FIG. 13A illustrates an example in which a notification screen 1307-1 including the basis of extraction of the first information displayed when the icon 1205-3 is selected in the screen of FIG. 12A or base data 1307-2 of calculation of the accuracy score is overlappingly displayed as another layer on the screen of FIG. 12A. The notification screen 1307-1 of FIG. 13A may be opaquely or translucently displayed to overlap at least some of the screen of FIG. 12A. Further, the notification screen 1307-1 of FIG. 13A may be implemented to be displayed only while a user's touch 1309 is maintained and to disappear when the touch ends. The notification screen 1307-1 of FIG. 13A may further include an icon 1307-3 for adopting first information.

Referring to FIG. 13B, when a figure icon 1305 displayed to correspond to the accuracy score in the screen of FIG. 12A is touched as indicated by reference numeral 1309, the electronic device may pop up the notification screen 1307-1 and display phone number-associated data 1307-2 that is the basis of calculation of the accuracy score on the popup notification screen 1307-1.

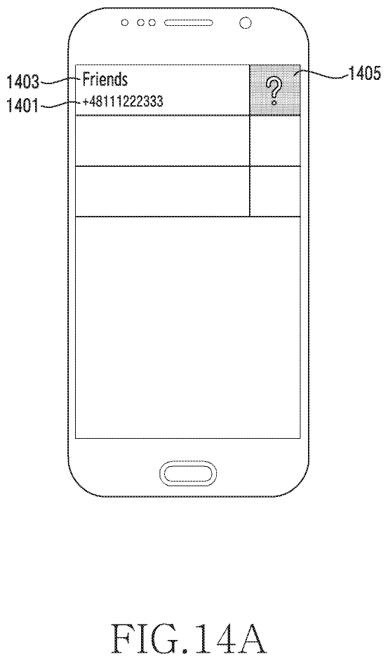

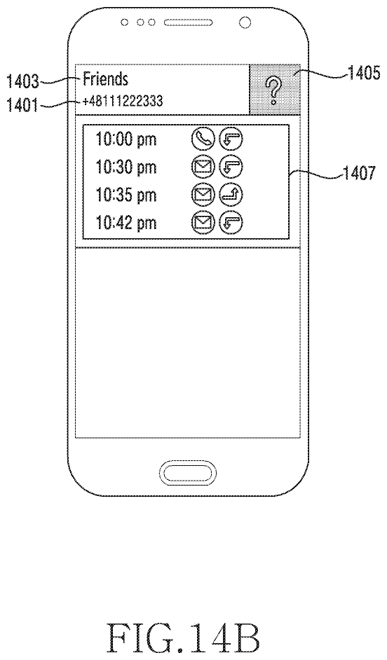

FIGS. 14A and 14B illustrate other examples of the UI of the electronic device according to various embodiments. Referring to FIG. 14A, first information 1403, for example, a word indicating social relations is displayed along with a detected phone number 1401, and an icon 1405 for identifying second information that is additional information on the first information is displayed around the phone number and the first information. Accordingly, when the icon 1405 is selected, a popup screen or a notification screen 1407 including phone number-associated data that is the basis of calculation of the proposed first information is displayed at least some of the entire screen. The associated data displayed as the second information includes a data list such as context information when a phone number is detected, for example, the generation of a voice call to the corresponding phone number, a time at which the voice call is generated, message transmission and reception, and a time at which message transmission and reception are performed.

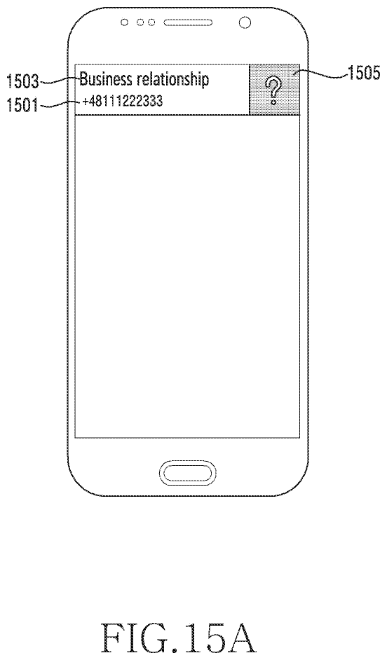

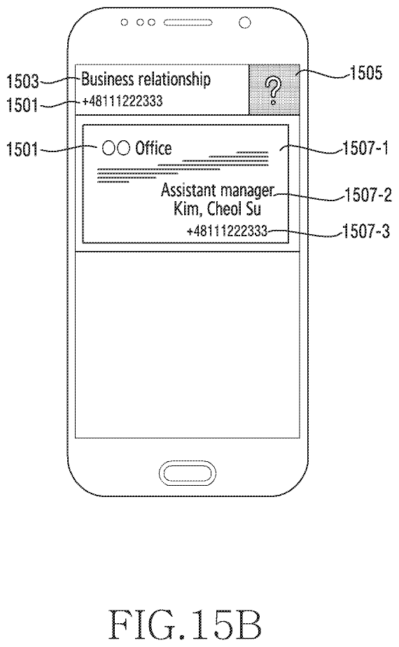

FIGS. 15A and 15B illustrate other examples of the UI of the electronic device according to various embodiments.

Referring to FIGS. 15A and 15B, first information 1503, for example, a word indicating social relations is displayed along with a detected phone number 1501, and an icon 1505 for identifying second information that is additional information of the first information is displayed around the phone number and the first information. Accordingly, when the icon 1505 is selected, the electronic device may display the second information including phone number-associated data that is the basis of calculation of the proposed first information through a notification screen 1507. The notification screen 1507 may be displayed, for example, below the screen displaying the first information. The associated data displayed as the second information may include an image such as a business card including the corresponding phone number.

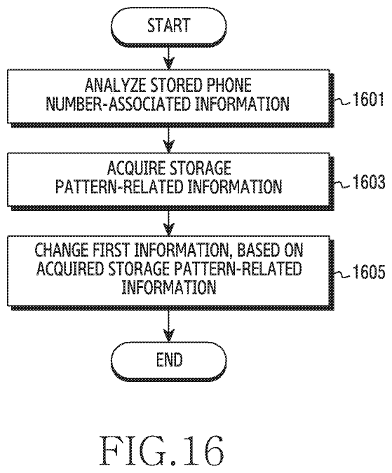

FIG. 16 illustrates another example of the operation of the electronic device for changing first information depending on a phone number storage pattern according to various embodiments. In FIG. 16, the processor 120 of the electronic device 101 may change extracted first information on the basis of a phone number storage pattern of the user.

Referring to FIG. 16, in operation 1601, the processor 120 of the electronic device 101 analyzes the stored phone number-associated information (for example, a phone book). The processor 120 may analyze phone number-associated information stored in the memory in order to acquire a storage pattern indicating a combination of elements included in the phone number-associated information stored in the memory. The phone number-associated information may include storage items such as a representative name related to a user of each phone number and a group to which the phone number belongs. For example, the processor 120 may analyze the storage items by determining whether an element such as a specific name, word, and special character is extracted from the representative name of the storage item a predetermined number of times or more. The element may include names, words, and special characters indicating informal or social relations or names, words, and special characters indicating emotion.

In operation 1603, the processor 120 acquires storage pattern-related information. The storage pattern-related information may include a storage pattern indicating a combination of elements included in phone number-associated information, obtained by analyzing the phone number-associated information. For example, a combination of arrangements of the elements indicating the sequence of the elements extracted a predetermined number of times or more in operation 1601 in the storage items and the number of extractions of the elements may be included in the storage pattern-related information.

In operation 1605, the processor 120 may change the first information on the basis of the acquired information. The processor 120 may delete some of the text indicating the first information on the basis of the storage pattern-related information or may make a change of adding or replacing the elements included in the storage pattern-related information. For example, the processor 120 may change arrangement of the extracted first information elements or adding a specific element extracted a predetermined number of time or more on the basis of the storage pattern-related information indicating a combination of arrangements of the elements extracted the predetermined number of times or more. In another example, when omission of a specific part (for example, last name) in the storage item is detected a predetermined number of times or more through a comparison with the first information, the omitted specific part may be deleted from the first information. In another example, a template may be configured on the basis of the storage pattern-related information, and text indicating the first information may be inserted. The template may include elements included in the storage pattern-related information, and the elements may be arranged in a predetermined combination thereof. The changed first information may be handled in the same way as the first information that is not changed after extraction according to the disclosed embodiment.

According to another embodiment, extracted elements may be classified according to information representing social relations extracted from associated data and included in the storage pattern-related information. For example, when a specific name, word, and special character is extracted from the elements included in the storage item a predetermined number of times or more according to classification of friends, acquaintances, strangers, and business relationships, the elements may be classified according to information representing the social relations and included in each piece of the storage pattern-related information. Thereafter, the processor 120 may differently change the first information extracted according to the information representing the social relations on the basis of the storage pattern-related information for each classification of the social relations.

Methods according to embodiments stated in claims and/or specifications of the disclosure may be implemented in hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The one or more programs may include instructions for allowing the electronic device to perform methods according to embodiments stated in the claims and/or specifications of the disclosure.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, the programs may be stored in a memory including any combination of some or all thereof. Further, the number of such memories may be plural.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. The storage device may access a device performing embodiments of the disclosure through an external port. Further, a separate storage device in a communication network may access the device performing embodiments of the disclosure.

In the detailed embodiments of the disclosure, elements included in the disclosure are expressed in a singular or plural form according to the presented detailed embodiment. However, the singular or plural expression is selected to be suitable for context for convenience of description, and the disclosure is not limited to a singular element or plural elements. Even elements expressed in the plural form may be configured as a singular, and even an element expressed in the singular form may be configured as a plural.

While the present has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

1. An electronic device comprising:
a display device; and
at least one processor,
wherein the at least one processor is configured to acquire data associated with a specific phone number, extract first information representing the phone number from the associated data according to a preset reference, and display the phone number and the first information on the display device.

2. The electronic device of claim 1, wherein the at least one processor is further configured to extract base data of extraction of the first information as second information.

3. The electronic device of claim 1, wherein the first information includes information indicating social relations, and the at least one processor is further configured to analyze text data and context information and extract the information indicating the social relations.

4. The electronic device of claim 2, wherein the at least one processor is configured to display the first information and the phone number on the display device using text information and visual items.

5. The electronic device of claim 4, wherein the at least one processor is further configured to display an icon for identifying the base data of extraction of the first information on the display device and, when the icon is touched, overlappingly display a second screen including the second information with at least some of a first screen of the display device on which the first information and the phone number are displayed.

6. The electronic device of claim 5, wherein the second information includes information indicating accuracy of extraction of the first information, and the at least one processor is configured to display the second information using at least one of a color, a brightness, and a size of the visual item.

7. The electronic device of claim 1, further comprising a memory,
wherein the at least one processor is configured to acquire storage pattern-related information, based on information associated with a phone number stored in the memory.

8. A method of operating an electronic device, the method comprising:
acquiring data associated with a specific phone number;
extracting first information representing the phone number from the associated data according to a preset reference; and
displaying the phone number and the first information on a display device.

9. The method of claim 8, further comprising extracting base data of extraction of the first information as second information.

10. The method of claim 8, wherein the first information includes information indicating social relations, and the extracting of the first information comprises analyzing text data and context information and extracting the information indicating the social relations.

11. The method of claim 9, wherein the displaying comprises displaying the first information and the phone number using text information and visual items.

12. The method of claim 11, wherein the displaying comprises:
displaying an icon for identifying the base data of extraction of the first information; and
when the icon is touched, overlappingly displaying a second screen including the second information with at least some of a first screen of the display device on which the first information and the phone number are displayed.

13. The method of claim 12, wherein the second information includes information indicating accuracy of extraction of the first information, and the displaying comprises displaying the second information using at least one of a color, a brightness, and a size of the visual item.

14. The method of claim 8, further comprising:
acquiring storage pattern-related information, based on phone number-associated information stored in a memory; and
changing first information, based on the acquired storage pattern-related information.

15. The method of claim 12, wherein the associated data includes at least one of text data, text data recognized from a voice or an image, and context information generated when the phone number is detected.

16. The electronic device of claim 7, wherein the at least one processor is configured to change the first information, based on the acquired storage pattern-related information.

17. The electronic device of claim 16, wherein the at least one processor is configured to display the changed first information on the display device.

18. The electronic device of claim 7, wherein the storage pattern-related information includes elements within phone number-associated information higher than or equal to a threshold value and information related to a combination of arrangement of the elements.

19. The electronic device of claim 1, wherein the associated data includes at least one of text data, text data recognized from a voice or an image, and context information generated when the phone number is detected.

20. The method of claim 14, wherein the displaying comprises displaying the changed first information on the display device, and the storage pattern-related information includes elements within phone number-associated information higher than or equal to a threshold value and information related to a combination of arrangement of the elements.
